(19) United States
(12) Patent Application Publication
(10) Pub. No.: US 2017/0082150 A1
(43) Pub. Date: Mar. 23, 2017

(54) FACE-SPLINE DRIVE ELEMENT WITH AXIAL RETAINER MECHANISM

(71) Applicant: FORD GLOBAL TECHNOLOGIES, LLC, Dearborn, MI (US)

(72) Inventors: WAYNE UHRICK, MACOMB, MI (US); KEVIN BROOKS, CLINTON TOWNSHIP, MI (US); NATHAN WIESELER, BEVERLY HILLS, MI (US); ALEX SZCZEPANIAK, ANN ARBOR, MI (US)

(21) Appl. No.: 14/856,786

(22) Filed: Sep. 17, 2015

(51) Int. Cl. F16B 13/00

(52) U.S. Cl. CPC F16D 3/18

(57) ABSTRACT

The present invention in one or more embodiments provides a halfshaft assembly, which includes a hub including a hub surface and a hub bore abutting the hub surface, the hub bore being defined by first and second bore-surfaces and a third bore-surface positioned there-between along an axial direction, the first bore-surface being smaller in cross-sectional dimension than the second bore-surface, and the hub face including thereupon female face-splines; and a constant-velocity joint including a joint face and a stem extending from the joint face along the axial direction, the joint face including thereupon male face-splines to engage the female face-splines of the hub at an engagement position, the stem defining thereupon a recess extending radially and spaced apart from the male face-splines. As detailed herein elsewhere, the halfshaft assembly is believed to reduce the occurrence of seal-pinching and spline block.

### TECHNICAL FIELD

The present invention relates to a face-spline drive element with axial retainer mechanism connecting the halfshaft and hub.

### BACKGROUND

In certain existing designs involving radial splines, the spline interface may be provided enough force of friction from the radial spline to maintain an interface between the hub and half-shaft during assembly before the nut is threaded and torqued down.

For instance, publication U.S. Pat. No. 7,121,632 discloses the employment of a retaining element in a halfshaft assembly involving a radial-spline shaft.

For instance also, publication CN204150022 discloses the employment of an elastic pad to be positioned between hub and the shaft body to reduce noise associated with axial movement.

### SUMMARY

In one or more embodiments, a halfshaft assembly includes a hub including a hub surface and a hub bore abutting the hub surface, the hub bore being defined by first and second bore-surfaces and a third bore-surface positioned there-between along an axial direction, the first bore-surface being smaller in cross-sectional dimension than the second bore-surface, and the hub face including thereupon female face-splines; and a constant-velocity joint including a joint face and a stem extending from the joint face along the axial direction, the joint face including thereupon male face-splines to engage the female face-splines of the hub at an engagement position, the stem defining thereupon a recess extending radially and spaced apart from the male face-splines.

The first bore-surface may differ from the second bore-surface in axial length.

The recess may be closer to an end surface of the stem than the male face-splines along the axial direction.

The halfshaft assembly may further include a ring to be at least partially received within the recess.

The ring may contact the second bore-surface at the engagement position.

The ring may include an elastic material.

The ring may be an open-loop ring.

The halfshaft assembly may further include a fastener to connect the face-spline constant-velocity joint and the hub by being at least partially received within the stem at the engagement position.

In another or more embodiments, a face-spline hub of a halfshaft is provided to include a hub wall defining therein a hub bore, the hub bore defined by first and second bore-surfaces and a third bore-surface positioned there-between along an axial direction, the first bore-surface being smaller in cross-sectional dimension than the second bore-surface; and a hub face including thereupon female face-splines to engage male face-splines of a face-spline constant-velocity joint at an engagement position.

In yet another or more embodiments, a face-spline constant-velocity joint of a halfshaft is provided to include a joint body including a joint face and a stem extending from the joint face along an axial direction, the joint face including thereupon male face-splines to engage female face-splines of a face-spline hub at an engagement position, the stem defining thereupon a recess extending radially and spaced apart from the male face-splines.

One or more advantageous features as described herein are believed to be readily apparent from the following detailed description of one or more embodiments when taken in connection with the accompanying drawings.

### BRIEF DESCRIPTION OF THE DRAWINGS

Reference is now made to the one or more embodiments illustrated in greater detail in the accompanying drawings and described below wherein:

FIG. 1 illustratively depicts a perspective view of a halfshaft assembly according to one or more embodiments;

FIG. 2 illustratively depicts an alternative view of a portion of the halfshaft assembly referenced in FIG. 1;

FIG. 3 illustratively depicts a cross-sectional view of a portion of the halfshaft assembly referenced in FIG. 1;

FIG. 3A illustratively depicts an enlarged partial view of the cross-sectional view referenced in FIG. 3; and

FIG. 4 illustratively depicts an enlarged perspective view of a constant-velocity joint employed in the halfshaft assembly referenced in FIG. 1.

### DETAILED DESCRIPTION OF ONE OR MORE EMBODIMENTS

As referenced in the FIG.s, the same reference numerals may be used herein to refer to the same parameters and components or their similar modifications and alternatives. These parameters and components are included as examples and are not meant to be limiting. The drawings referenced herein are schematic and associated views thereof are not necessarily drawn to scale.

The present invention in one or more embodiments is believed to be advantageous in at least providing a retention structure and/or mechanism where a face-spline halfshaft or side shaft and a coordinating hub may at least temporarily engage with each other along an axial direction to form a connected item, which is then capable of traveling down along an assembly line by itself. This design and/or mechanism is not necessarily intended for a final hub retention and additional retention device and/or system may be employed for a more desirable connection. However, and as detailed herein elsewhere, the retention mechanism according to the present invention in one or more embodiments nevertheless provides a readily accessible way via which the face-spline halfshaft and the coordinating hub may be favorably engaged temporarily.

This advantage complements the employment of the face-spline halfshaft where axial connection between the halfshaft and the hub may have not been previously available and an operator would have to borrow an extra helping hand to hold the two while trying to attach thereto a third component.

Moreover an existing assembly line ordinarily used with a radial-spline halfshaft may be readily used for the face-spline halfshaft because an otherwise extra step of holding together the face-spline halfshaft with the hub may be eliminated with the use of the retention mechanism. This alone is believed to deliver desirable labor and cost efficiencies.

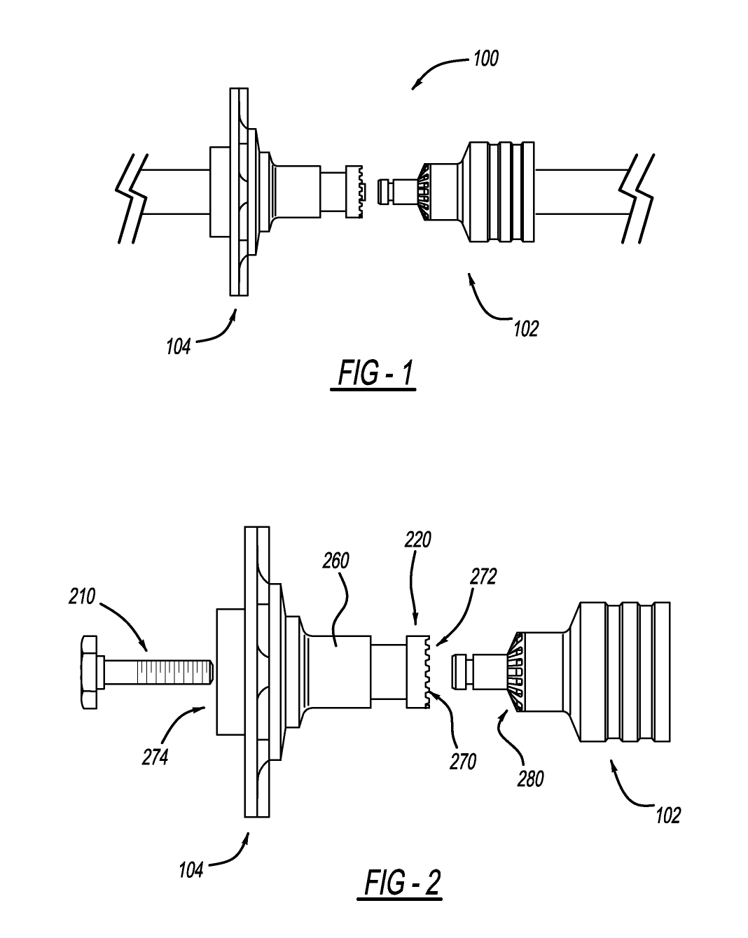

In one or more embodiments, and further in view of FIG. 1 through FIG. 4, a halfshaft assembly generally shown at 100 includes a hub 104 in communication with a constant-velocity joint 102 along an axial direction A.

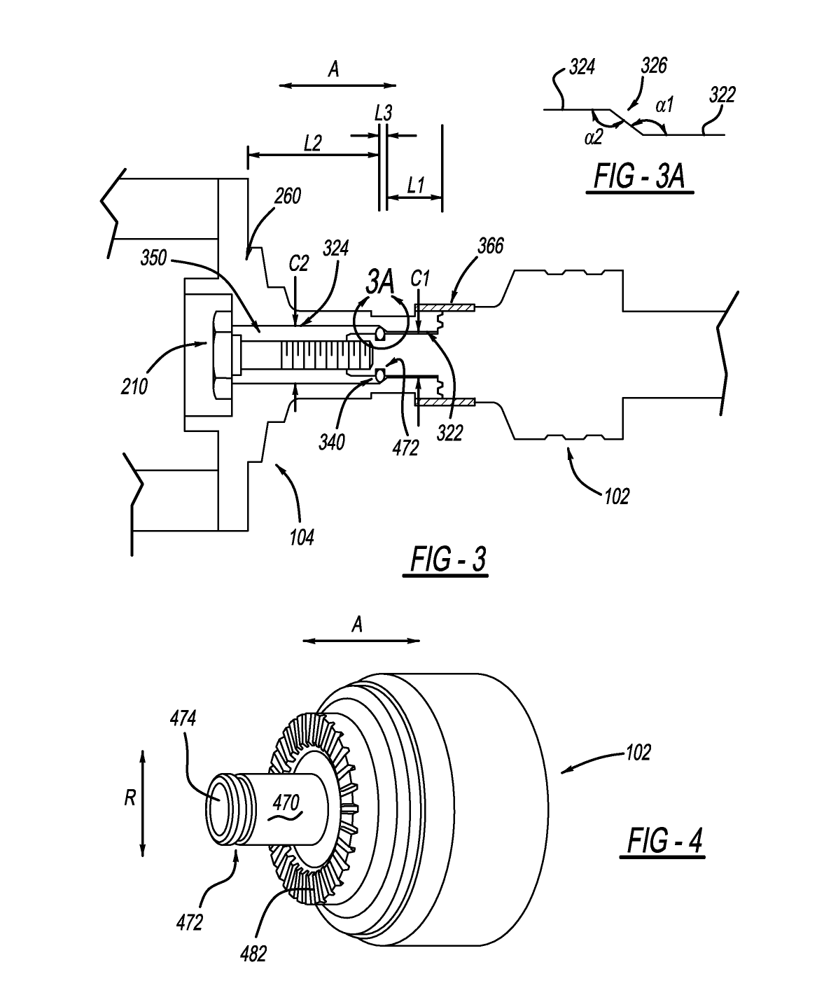

Referring back to FIG. 1 and further in view of FIG. 2 and FIG. 3, the hub 104 includes a hub surface 220 and a hub bore 350 abutting the hub surface 220, the hub bore 350 being defined by first and second bore-surfaces 322, 324 and a third bore-surface 326 positioned there-between along the axial direction A, the first bore-surface 322 being of a first cross-sectional dimension C1 that is smaller than a second cross-sectional dimension C2 of the second bore-surface, and the hub face 220 including thereupon female face-splines 270 to engage male face-splines 280 of the constant-velocity joint 102 at an engagement position such as the position illustratively depicted in FIG. 3.

The constant-velocity joint 102 includes a joint face 482 and a stem 470 extending from the joint face 482 along the axial direction A, the joint face 482 including thereupon male face-splines 280 to engage the female face-splines 270 of the hub 104 at an engagement position such as the position illustratively depicted in FIG. 3, the stem 470 defining thereupon a recess 472 extending along a radial direction R and being spaced apart from the male face-splines 280 along the axial direction.

Referring back to FIG. 3, the first bore-surface 322 is of a first axial length L1 different from a second axial length L2 of the second bore-surface along the axial direction A. In certain embodiments, the first axial length L1 is smaller than the second axial length L2.

Referring again back to FIG. 3, the third bore-surface 326 is of a third axial length L3 different from at least one of the first axial length L1 and the second axial length L2. In certain embodiments, the third axial length L3 is smaller than the first axial length L1 and the second axial length L2.

Referring again back to FIG. 3 and further in view of FIG. 3A, the second bore-surface 326 may connect both the first bore surface 322 and the second bore surface 324, and accordingly the second bore-surface 326 is at a first angle α1 to the first bore surface 322 and at a second angle α2 to the second bore surface 324. At least one of the first angle α1 and the second angle α2 is greater than 90 degrees and smaller than 180 degrees.

Referring back to FIG. 4, the recess 472 may be closer to an end surface 474 of the stem 470 than the male face-splines 280 along the axial direction A. Without wanting to be limited to any particular theory, this configuration is believed to be advantageous to facilitate engagement of the constant-velocity joint 102 to the hub 104, and further to reduce the occurrence of lip-pinching of the face-splines interface seal 366 relative to the constant-velocity joint 102.

At an engagement position such as the engagement position illustratively depicted in FIG. 3, a ring 340 may be employed to be received between the recess 472 of the constant-velocity joint 102 and the second bore-surface 326 of the hub 104. The ring 340 may be pre-assembled onto the constant-velocity joint 102, for instance, by being at least partially received within the recess 472.

During orientation and engagement, the stem 470 travels into the hub bore 350 and during the insertion process, the ring 340 may expand upon contacting the second bore-surface 326. At this junction the constant-velocity joint 102 is considered at least temporarily engaged to the hub 104 and together forming an engaged unit. Because a casual disengagement may be effectively discouraged due to the configuration of the bore-surfaces 322, 324 and 326, the engaged unit may be handled this point onward with greater ease and downstream processing thereof may be met with reduced labor intensity.

The ring 340 may include an elastic material such that the ring 340 becomes compressible during transit through the first bore-surface 322 and becomes expandable upon reaching the third bore-surface 326 which is of a greater cross-sectional dimension than the first bore-surface 322. Non-limiting examples of the elastic material include natural and/or synthetic polymers such as rubber and rubber blends.

In certain embodiments, the ring 340 may be an open-loop ring both compressible and expandable as desired. In this configuration, the ring 340 may but does not necessarily have to include an elastic material. For instance, the ring 340 may include or be formed of a metallic material. This may be particularly suitable in the vehicular operating environment.

Referring back to FIG. 2 and in view of FIG. 3, a fastener 210 may be employed to connect the constant-velocity joint 102 and the hub 104 by being at least partially received within the stem 470 at the engagement position. The fastener 210 may be introduced to secure the connection after the constant-velocity joint 102 and the hub 104 have been aligned with an engagement via the recess 472 and the second bore-surface 326. As mentioned herein elsewhere, the engagement essentially renders the constant-velocity joint 102 and the hub 104 as a pre-assembled unit, which the operator may hold in one hand and the other hand may be available for attaching the fastener 210 to the pre-assembled unit. Accordingly the operator may complete the entire assembly without the necessity of additional operators or manufacturing assists.

Referring back to FIG. 3, the third bore-surface 326 as positioned between the first and second bore-surfaces 322, 324 may be alternatively termed a chamfer surface. The chamfer surface as thus configured may be readily formed even after the hub wall 260 of the hub 104 has already been pre-formed. For instance, the first bore-surface 322 may be formed via machining by a machining head via entry through a first end 272 the hub 104, the second bore-surface 324 may be formed via machining by the same or another machining head via entry through a second end 274 of the hub 104. The third bore-surface 324 may naturally result with the formation of the first and second bore-surfaces 322, 324.

Instead of the chamfer surface mentioned herein, a groove (not shown) may be machined onto the hub bore 350 to engage the recess 472 through the ring 340. However, it may be difficult if not all impossible to create such a groove after the hub wall 260 has already been formed and shaped. Moreover, such a groove may not provide the clearance needed to allow for an engagement of the male face-splines 280 and the female face-splines 270. Therefore such a chamfer surface design on the hub bore 350 according to one or more embodiments is believed to impart enhanced easiness in preparing the hub bore 350 to receive the ring 340 so as to effect an engagement.

In addition, the chamfer design in direct comparison to a groove design is believed to help reduce the likelihood of the groove interfering with torqueing down the bolt. Without wanting to be limited to any particular theory, it is believed that the groove is to positively locate the relative position of the hub and halfshaft and the groove does not readily allow for travel of the constant-velocity joint towards the hub along the axial direction A once the ring and the groove are engaged.

In the chamfer design referenced herein according to the present invention in one or more embodiments, diameter C2 allows for the ring 340 to move reasonably freely once even after the distance L2 is travelled. The distance L1 may be determined to be the distance where spline block is prevented through design and the distance where proper spline tooth engagements is guaranteed. The phrase “spline block” may refer to a scenario or phenomena where there is improper tooth engagement by way of each set of face splines meeting at respective high points of the spline geometry. Because operators may not be readily aware of spline block occurrence, spline block should be avoided through design. The present invention in or more embodiments as described herein removes the worry of spline block because the circlip may not engage unless the teeth are fully engaged.

In one or more embodiments, the present invention as set forth herein is believed to have overcome certain challenges associated with the assembly and employment of face-spline halfshaft. However, one skilled in the art will readily recognize from such discussion, and from the accompanying drawings and claims that various changes, modifications and variations can be made therein without departing from the true spirit and fair scope of the invention as defined by the following claims.

What is claimed is:

1. A halfshaft assembly, comprising:
a hub including a hub surface and a hub bore abutting the hub surface, the hub bore being defined by first and second bore-surfaces and a third bore-surface positioned there-between along an axial direction, the first bore-surface being smaller in cross-sectional dimension than the second bore-surface, and the hub face including thereupon female face-splines; and
a constant-velocity joint including a joint face and a stem extending from the joint face along the axial direction, the joint face including thereupon male face-splines to engage the female face-splines of the hub at an engagement position, the stem defining thereupon a recess extending radially and spaced apart from the male face-splines.

2. The halfshaft assembly of claim 1, wherein the first bore-surface differs from the second bore-surface in axial length.

3. The halfshaft assembly of claim 1, wherein the recess is closer to an end surface of the stem than the male face-splines along the axial direction.

4. The halfshaft assembly of claim 1, further comprising a ring to be at least partially received within the recess.

5. The drive shaft assembly of claim 1, wherein the ring contacts the second bore-surface at the engagement position.

6. The halfshaft assembly of claim 1, wherein the ring includes an elastic material.

7. The halfshaft assembly of claim 1, wherein the ring is an open-loop ring.

8. The halfshaft assembly of claim 1, further comprising a fastener to connect the constant-velocity joint and the hub by being at least partially received within the stem at the engagement position.

9. A face-spline hub of a halfshaft, comprising:
a hub wall defining therein a hub bore, the hub bore defined by first and second bore-surfaces and a third bore-surface positioned there-between along an axial direction, the first bore-surface being smaller in cross-sectional dimension than the second bore-surface; and
a hub face including thereupon female face-splines to engage male face-splines of a face-spline constant-velocity joint at an engagement position.

10. The hub of claim 9, wherein the first bore-surface differs from the second bore-surface in axial length.

11. A face-spline constant-velocity joint of a halfshaft, comprising:
a joint body including a joint face and a stem extending from the joint face along an axial direction, the joint face including thereupon male face-splines to engage female face-splines of a face-spline hub at an engagement position, the stem defining thereupon a recess extending radially and spaced apart from the male face-splines.

12. The face-spline constant-velocity joint of claim 11, wherein the recess is closer to an end surface of the stem than the male face-splines along the axial direction.

13. The face-spline constant-velocity joint of claim 11, further comprising a ring to be at least partially received within the recess.

14. The face-spline constant-velocity joint of claim 11, wherein the ring includes an elastic material.

15. The face-spline constant-velocity joint of claim 11, wherein the ring is an open-loop ring.

16. The face-spline constant-velocity joint of claim 11, wherein the stem is smaller in cross-sectional dimension than the joint face.
